(19) United States
(12) Patent Application Publication
(10) Pub. No.: US 2016/0110386 A1
(43) Pub. Date: Apr. 21, 2016

(54) AUTOMATIC IDENTITY RECONCILIATION USING IMAGE PROCESSING

(71) Applicant: CA, INC., New York, NY (US)

(72) Inventor: Serguei Mankovskii, Morgan Hill, CA (US)

(73) Assignee: CA, INC., New York, NY (US)

(21) Appl. No.: 14/515,843

(22) Filed: Oct. 16, 2014

(51) Int. Cl. G06F 17/30

(52) U.S. Cl. CPC G06F 17/30256; G06F 17/30879

(57) ABSTRACT

A method of automatic identity reconciliation includes identifying a plurality of identifiers that are spaced apart from each other within a digital image of a physical component in a distributed computer system. The method includes retrieving an attribute of the physical component based on one of the plurality of identifiers. Moreover, the method includes storing the plurality of identifiers with an association to the attribute of the physical component. Related apparatuses and computer program products are disclosed.

### BACKGROUND

The present disclosure relates to methods, apparatuses, and computer program products, and in particular to identity reconciliation and image processing methods, apparatuses, and computer program products.

Large Information Technology (IT) environments may include a variety of elements. For example, a data center may include data center equipment such as servers, network storage devices, computing devices, network routers, network gateways, wireless/wired network interface devices, etc. Moreover, the data center may include a large quantity of a particular type of IT element. As an example, the data center may include a large quantity of servers. Each of the servers may be associated with multiple identifiers, such as a name, a number, and an address.

### SUMMARY

Some embodiments disclosed herein are directed to a method of automatic identity reconciliation using image processing. The method includes identifying a plurality of identifiers that are spaced apart from each other within a digital image of a physical component in a distributed computer system. The method includes retrieving an attribute of the physical component based on one of the plurality of identifiers. Moreover, the method includes storing the plurality of identifiers with an association to the attribute of the physical component.

Some embodiments disclosed herein are directed to an apparatus that includes a processor and a memory coupled to the processor. The memory includes computer readable program code that when executed by the processor causes the processor to perform operations including identifying a plurality of identifiers that are spaced apart from each other within a digital image of a physical component in a distributed computer system. The operations include retrieving an attribute of the physical component based on one of the plurality of identifiers. Moreover, the operations include storing the plurality of identifiers with an association to the attribute of the physical component.

Some embodiments disclosed herein are directed to a computer program product including a computer readable storage medium that includes computer readable program code embodied in the computer readable storage medium. The computer readable program code includes computer readable program code to identify a plurality of identifiers that are spaced apart from each other within a digital image of a physical component in a distributed computer system. The computer readable program code includes computer readable program code to retrieve an attribute of the physical component based on one of the plurality of identifiers. Moreover, the computer readable program code includes computer readable program code to store the plurality of identifiers with an association to the attribute of the physical component.

It is noted that aspects described with respect to one embodiment may be incorporated in different embodiments although not specifically described relative thereto. That is, all embodiments and/or features of any embodiments can be combined in any way and/or combination. Moreover, other resource management nodes, distributed computing systems, methods, apparatuses, and/or computer program products according to embodiments will be or become apparent to one with skill in the art upon review of the following drawings and detailed description. It is intended that all such additional resource management nodes, distributed computing systems, methods, apparatuses, and/or computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1A is a schematic illustration of a cabinet layout in a distributed computer system that is configured as a data center according to some embodiments;

FIG. 1B is a perspective view of a data center according to some embodiments;

FIG. 2A is a perspective view of a plurality of data center equipment according to some embodiments;

FIG. 2B illustrates a digital image of the plurality of data center equipment of FIG. 2A, according to some embodiments;

FIGS. 3A-3D are flowcharts that illustrate operations of automatic identity reconciliation using image processing according to some embodiments; and

FIG. 4 is a block diagram of an apparatus that is configured according to some embodiments.

### DETAILED DESCRIPTION

In the following detailed description, numerous specific details are set forth to provide a thorough understanding of embodiments of the present disclosure. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As demand for higher-speed data communication increases, data centers are proliferating around the world. Data centers may include a multitude of data center equipment such as servers. As an example, a data center may include thousands of servers housed in a single physical facility. The servers may generally be arranged in racks, which themselves may be arranged in aisles of the data center. These servers may be physically moved, removed from service upon fault detection, and/or temporarily taken out of service for maintenance. Data center operators may desire to know information, such as location and attributes, about each of the servers in the data center to improve performance of the overall data center.

For ease of discussion, a non-limiting, ongoing example of a data center including data center equipment is discussed herein. The techniques discussed, however, may be applied to other physical spaces such as, for example, a rental car parking lot including automobiles, or any other physical environment where a large number of physical objects/components are present.

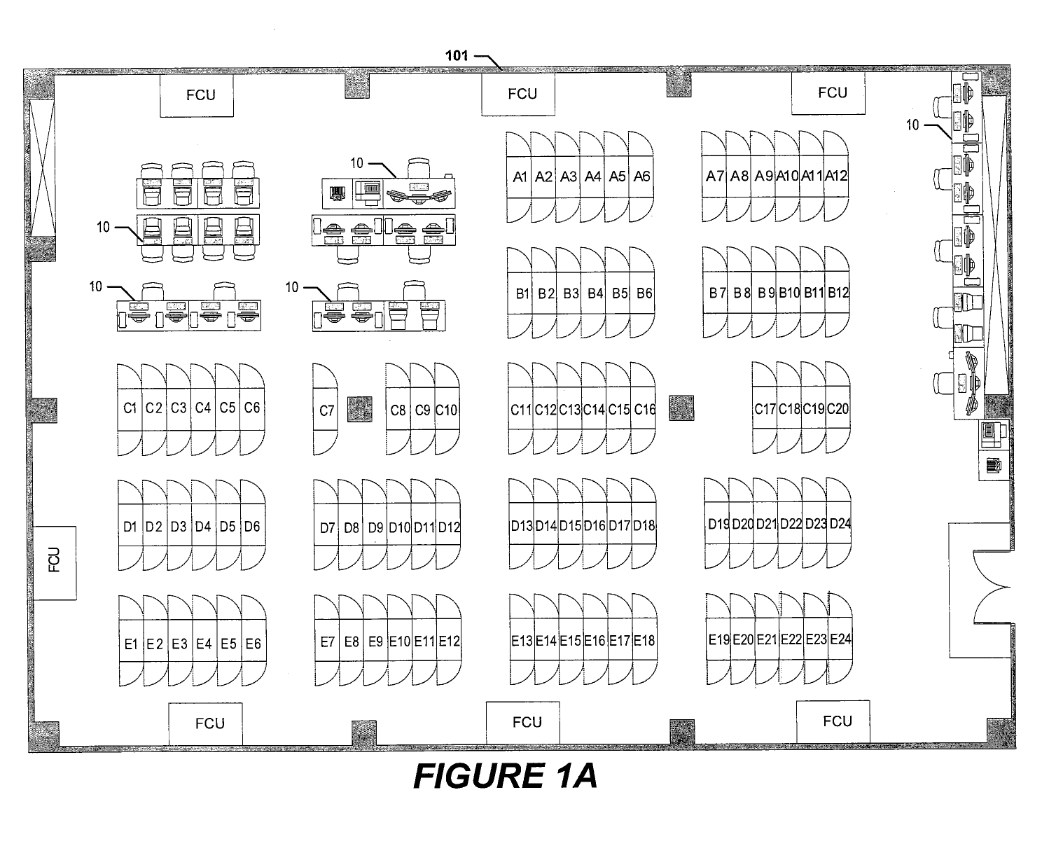

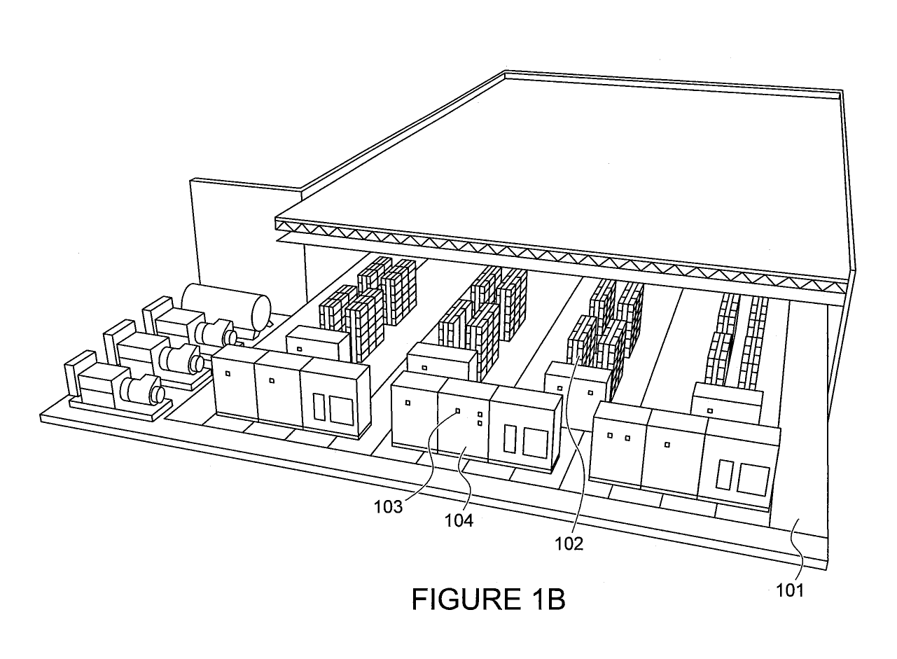

FIG. 1A is a schematic illustration of a cabinet layout in a distributed computer system that is configured as a data center 101 according to some embodiments described herein. The data center 101 can include hundreds or thousands of data servers, also referred to as computing resources, which are mounted to physical racks within cabinets. The example data center 101 includes cabinets (also commonly referred to as “racks”) A1-12, B1-12, C1-20, D1-24, and E1-24 arranged in rows and columns for accessibility by operators. Each cabinet contains physical storage spaces (e.g., mounting spaces on rack(s), use/unit spaces “U-spaces”, etc.) where data servers and other resources can be installed to host guest virtual machines and/or applications, as described further below. Facilities Control Units (FCU) have electrical power sources (e.g., power conditioning and backup power sources), cooling devices, and other equipment that supports operation of resources in the cabinets. Each cabinet can include a local electrical power supply device(s) and a cooling device(s) that cools resources mounted in the cabinet.

The data servers can consume substantial amounts of electrical power, occupy significant amounts of physical rack storage space and floor space, and require substantial cooling heat transfer to remain within an acceptable operational temperature range. The electrical power, physical rack storage space and floor space, cooling, and other support systems are examples of infrastructure resources provided by the data center 101 to support operation of the data servers.

In accordance with some embodiments, the data center 101 includes a resource management node that may reside within one or more of the cabinets or separate therefrom (e.g., within an operator work station or outside the data center), and is configured to operate according to one or more embodiments disclosed herein. A plurality of operator work stations 10 are illustrated as having computer processing and display devices for use by operators to monitor operation of the data center 101 and control operation of the resource management node according to one or more embodiments disclosed herein.

Each cabinet in the data center 101 includes data network interfaces, also referred to as network resources, that communicatively interconnect resources in the cabinets. The data servers perform computer operations that provide a plurality of guest Virtual Machines (VMs) within a plurality of VM clusters. Each VM cluster can include a plurality of guest VMs, and each VM cluster can reside on different data servers or may be distributed across more than one data server.

In some embodiments disclosed herein, an operator can take a digital photograph of a rack containing physical resource components such as servers, power supplies, and networking equipment. Each of these physical resource components may have a plurality of identifiers thereon. For example, different identifiers on a physical resource component may correspond to an asset number in an asset management system, an Internet Protocol (IP) address in a network management system, and a name in an application management system, respectively. Accordingly, image processing can be performed to identify the plurality of identifiers on the physical resource component and to link the identifiers to each other, thus providing identity reconciliation for the physical resource component. Moreover, in some embodiments, the image processing operations may be repeated for a plurality of the physical resource components, thus providing identity reconciliation for the plurality (e.g., for all, or for a subset) of the physical resource components in the digital photograph.

FIG. 1B is a perspective view of a data center 101 according to some embodiments described herein. The data center 101 may be a facility to house computer systems and/or associated physical objects, as described with respect to FIG. 1A. The data center 101 may include data center equipment such as communications equipment 102 including data networking equipment, telecommunications equipment, storage systems, servers, routers, gateways, and/or equipment racks arranged in aisles, rows, and/or stacked in columns. Data center equipment may include supporting equipment 104 such as power supplies, connectors, wiring, environmental controls such as Heating, Ventilating, and Air-Conditioning (HVAC), fire suppression equipment, and/or various security devices. Each data center equipment 102 and/or 104 may include a coded reference identifier 103.

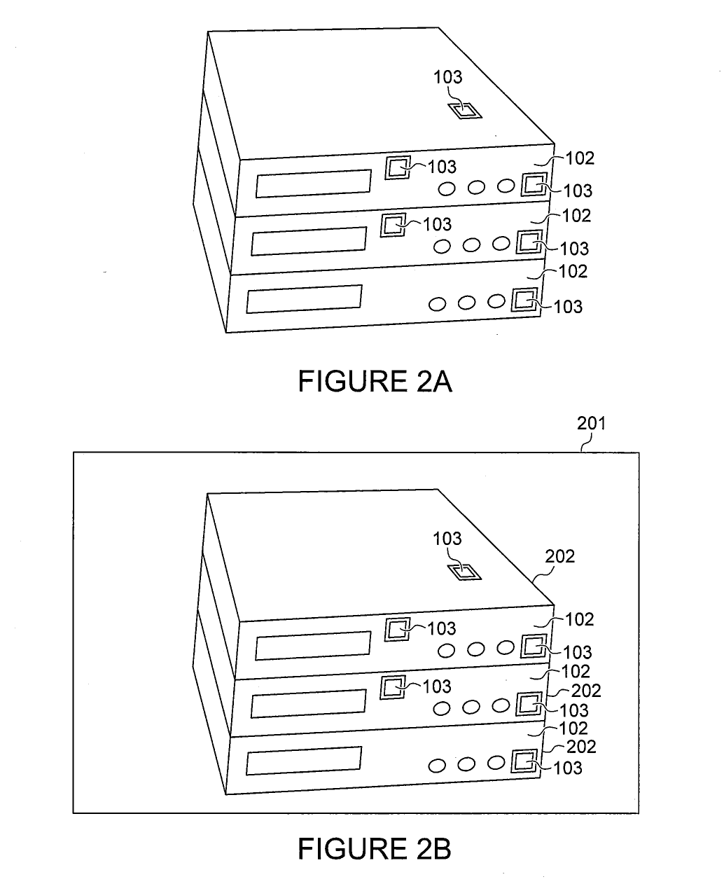

FIG. 2A illustrates a plurality of data center equipment according to some embodiments. A plurality of data center equipment 102 and/or 104 may be located in the data center 101, specifically in a given rack number of a given aisle number of the data center 101. Each of the plurality of data center equipment 102 and/or 104 may include one or more coded reference identifiers 103 affixed thereto (or otherwise provided thereon).

FIG. 2B illustrates a digital image 201 of the plurality of data center equipment 102 and/or 104 as in FIG. 2A, according to some embodiments. The digital image 201 may include images of the plurality of data center equipment 102 and/or 104. Specifically, the digital image 201 includes an image of coded reference identifiers 103 that are affixed to (or otherwise provided on) the plurality of data center equipment 102 and/or 104. Moreover, each of the plurality of data center equipment 102 and/or 104 may have a boundary 202. A particular boundary 202 of a particular physical object (e.g., a particular data center equipment 102 or 104) may assume any shape of the physical object and may demark an area in the digital image 201 that represents the physical object. The boundary 202 may be determined for a two-dimensional and/or perspective view of the digital image 201. A coded reference identifier 103 contained within the boundary 202 of the physical object may be a Quick Response Code (QR code), a barcode, a Universal Product Code (UPC) symbol, and/or any other machine-optically-recognizable coding identifier including a reference to the physical object. The coded reference identifier 103 may be optically recognized, according to some embodiments, by applying various image processing and/or image search algorithms.

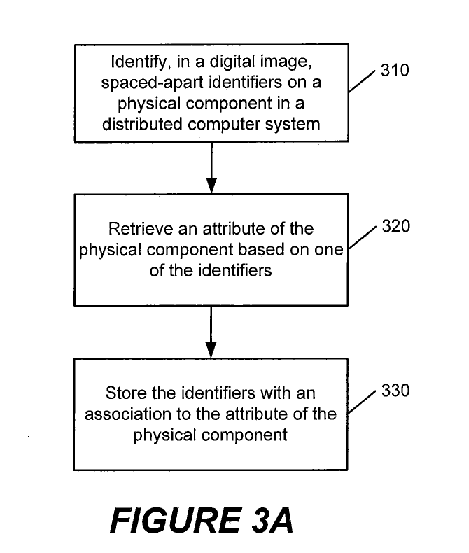

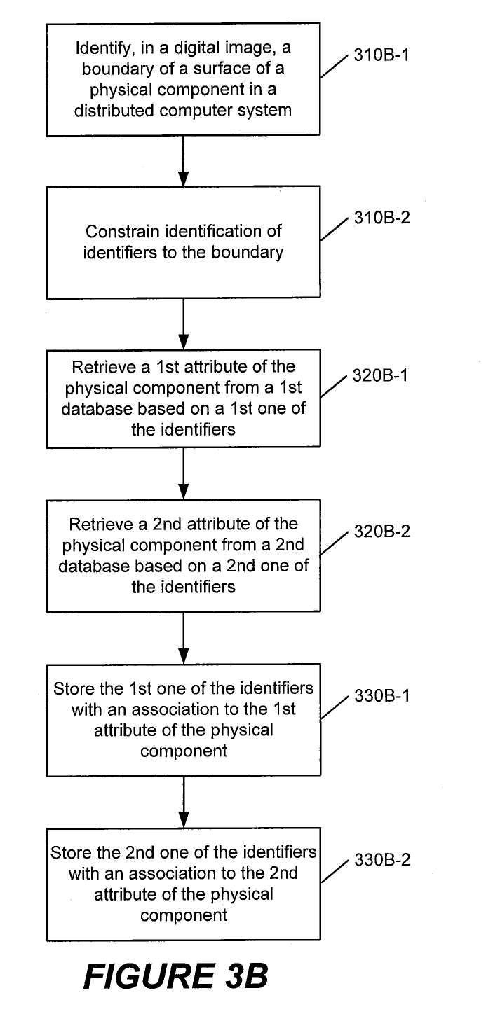

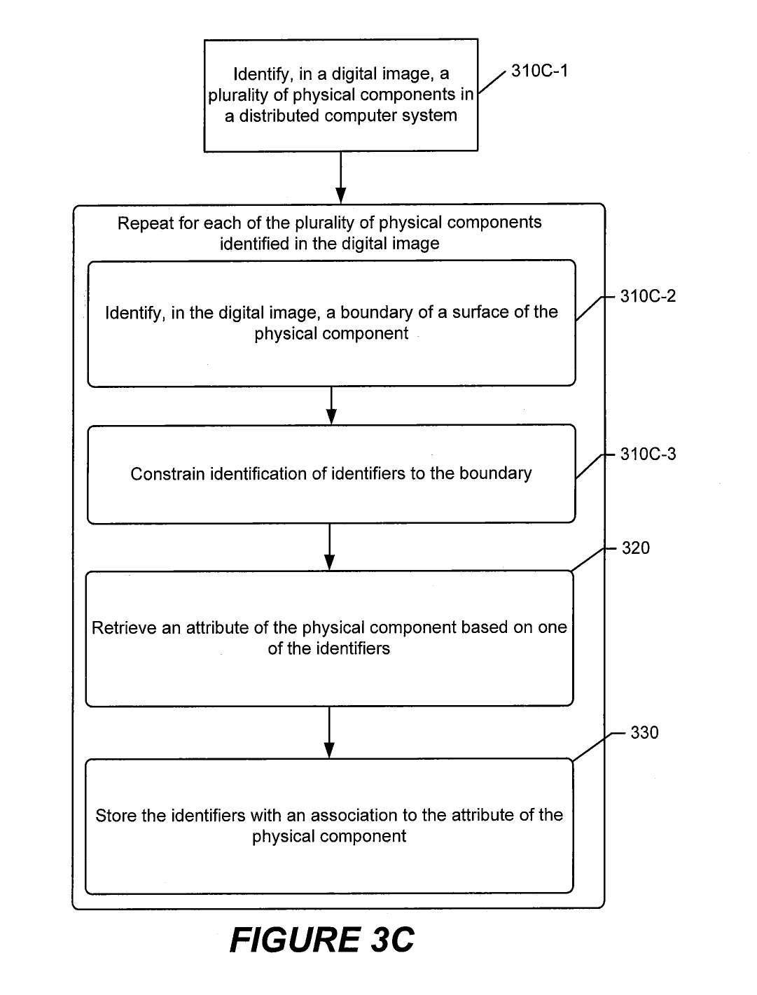

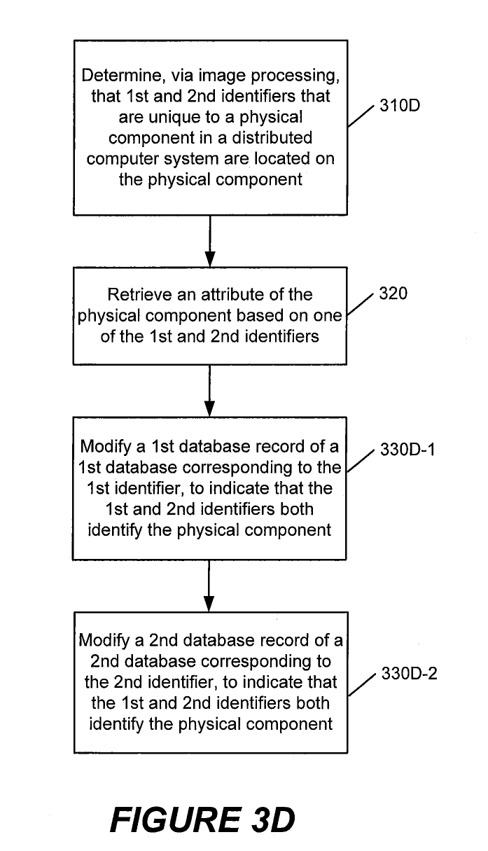

FIGS. 3A-3D are flowcharts that illustrate operations of automatic identity reconciliation using image processing, according to some embodiments described herein. Referring to FIG. 3A, the operations include identifying (Block 310), via image processing, a plurality of identifiers 103 that are spaced apart from each other within a digital image 201 of a physical component in a distributed computer system. For example, FIGS. 2A and 2B illustrate a physical object/component such as a particular data center equipment 102 whose identifiers 103 may be identified in a digital image 201 by image processing. A physical object/component, as described herein, may refer to anything on which identifiers 103 may be physically located, including an element of an IT infrastructure (which may also be referred to as a Configuration Item (CI)), a vehicle, or a delivery parcel.

Moreover, image processing may include any form of signal processing for which the input is an image, such as a photograph or video frame. The output of image processing may be either an image and/or a set of characteristics or parameters related to the image. Image processing may refer to digital image processing, optical image processing, and/or analog image processing.

Referring still to FIG. 3A, operations of automatic identity reconciliation include retrieving (Block 320) an attribute of the physical component based on one of the plurality of identifiers 103. For example, in some embodiments, the attribute includes a rack number of the physical component in the distributed computer system. Accordingly, in some embodiments, operations of retrieving (Block 320) the attribute include retrieving the rack number of the physical component based on one of the plurality of identifiers 103. Additionally or alternatively, in some embodiments, the attribute includes a model number, a serial number, an asset number, an address (e.g., an IP address), a performance specification (e.g., speed, storage capacity, etc.), an element name, a model name, and/or a manufacturer name of the physical component. Moreover, operations of retrieving (Block 320) the attribute may be referred to herein as performing a database query. As an example, in response to identifying the plurality of identifiers 103, respective queries may be performed in different databases, using the identifiers 103.

Referring again to FIG. 3A, operations of automatic identity reconciliation include storing (Block 330) the plurality of identifiers 103 with an association to the attribute of the physical component. In some embodiments, the operations of Block 330 may be performed for a plurality of physical components in the distributed computer system. For example, the physical component illustrated in Block 330 may include a first physical component among the plurality of physical components, the plurality of identifiers 103 may include a first plurality of identifiers 103 that are located on the first physical component, and the attribute may include a first attribute of the first physical component. Also, a second physical component among the plurality of physical components in the distributed computer system may have a second plurality of identifiers 103 thereon. Accordingly, in some embodiments, operations of storing (Block 330) the plurality of identifiers 103 may include storing the first plurality of identifiers 103 with an association to the first attribute of the first physical component, as well as storing the second plurality of identifiers 103 with an association to a second attribute of the second physical component.

Moreover, in some embodiments that include the first and second physical components, operations of identifying (Block 310) the spaced-apart plurality of identifiers 103 may include identifying, within the digital image 201, a first plurality of identifiers 103 that are spaced apart from each other on the first physical component and a second plurality of identifiers 103 that are spaced apart from each other on a second physical component. Also, operations of retrieving (Block 320) the attribute may include retrieving a first attribute of the first physical component based on one of the first plurality of identifiers 103 and retrieving a second attribute of the second physical component based on one of the second plurality of identifiers 103.

In some embodiments, the operations of Block 320 may be optional. Moreover, the attribute illustrated in Blocks 320 and 330 may be optional. Accordingly, operations of automatic identity reconciliation may include (i) identifying (Block 310) the spaced-apart plurality of identifiers 103 and then (ii) storing the spaced-apart plurality of identifiers 103 together (e.g., in a single record indicating that they pertain to the same object), without performing the operations of Block 320 and/or without using an attribute in Block 330.

Referring now to FIG. 3B, operations of identifying (Block 310, FIG. 3A) the plurality of identifiers 103 may include identifying (Block 310B-1), in the digital image 201, a boundary 202 of the physical component in the distributed computer system. For example, the boundary 202 of the topmost data center equipment 102 of FIG. 2B may include the side surface that is illustrated as having two identifiers 103 thereon and/or the top surface that is illustrated as having one identifier 103 thereon. As an example, identifying (Block 310B-1) the boundary 202 may distinguish between different servers or between different server racks. Moreover, the operations of identifying (Block 310, FIG. 3A) the plurality of identifiers 103 may further include constraining operations of identifying (Block 310B-2) the plurality of identifiers 103 to occurring within the boundary 202 of the surface of the physical component in the digital image 201.

The operations of Block 310B-2 of FIG. 3B provide an example of excluding, from the plurality of identifiers 103, any identifiers 103 that are not determined to be located on a surface of the physical component within the digital image 201. Additionally or alternatively, in some embodiments, operations of identifying (Block 310, FIG. 3A) the plurality of identifiers 103 may include excluding, from the plurality of identifiers 103, any identifiers 103 that are not determined to be located at least a threshold distance apart from each other on the surface of the physical component within the digital image 201. Accordingly, the constraining/excluding operations described herein may reduce the likelihood of misinterpreting a single identifier 103 as being multiple identifiers 103, or of misinterpreting identifiers 103 of different physical components as being on the same physical component.

Referring still to FIG. 3B, operations of retrieving (Block 320, FIG. 3A) the attribute of the physical component may include retrieving (Block 320B-1) a first attribute of the physical component from a first management database based on a first one of the plurality of identifiers 103, and retrieving (Block 320B-2) a second attribute of the physical component from a second management database based on a second one of the plurality of identifiers 103. In some embodiments, retrieving (Block 320B-1) the first attribute of the physical component from the first management database based on the first one of the plurality of identifiers 103 may include querying an asset management database using the first one of the plurality of identifiers 103, to retrieve an asset number identity of the physical component. Moreover, in some embodiments, retrieving (Block 320B-2) the second attribute of the physical component from the second management database based on the second one of the plurality of identifiers 103 may include querying a network management database using the second one of the plurality of identifiers 103, to retrieve an Internet Protocol (IP) address of the physical component.

Referring again to FIG. 3B, operations of storing (Block 330, FIG. 3A) the plurality of identifiers 103 may include storing (Block 330B-1) the first one of the plurality of identifiers 103 with an association to the first attribute of the physical component, and storing (Block 330B-2) the second one of the plurality of identifiers 103 with an association to the second attribute of the physical component.

Referring now to FIG. 3C, operations of identifying (Block 310, FIG. 3A) the plurality of identifiers 103 may include identifying (Block 310C-1), within the digital image, a plurality of physical components in the distributed computer system. Moreover, operations of identifying (Block 310B-1, FIG. 3B) the boundary 202 and constraining (Block 310B-2, FIG. 3B) identification of identifiers 103 to the boundary 202 may include repeating (Block 310C-2) the identifying of the boundary 202 and repeating (Block 310C-3) the constraining of the identifying of the plurality of identifiers 103 to occurring within the boundary 202, so that each of the plurality of physical components identified within the digital image 201 performs the operations of Blocks 310C-2 and 310C-3. Also, each of the plurality of physical components identified within the digital image 201 may perform the operations of Blocks 320 and 330.

Referring now to FIG. 3D, the plurality of identifiers 103 are unique to the physical component in the distributed computer system. In particular, operations of identifying (Block 310, FIG. 3A) the plurality of identifiers 103 include determining (Block 310D), via image processing of the digital image 201, that the plurality of identifiers 103 that are unique to the physical component are located on the physical component.

For example, in some embodiments, the plurality of identifiers 103 that are unique to the physical component include different first and second Quick Response (QR) codes that are on the physical component. In such embodiments, operations of determining (Block 310D) that the plurality of identifiers 103 that are unique to the physical component are located on the physical component include determining, via the image processing, that the different first and second QR codes are located on the physical component.

Moreover, in some embodiments, operations of storing (Block 330, FIG. 3A) the plurality of identifiers 103 include associating the plurality of identifiers 103, that are unique to the physical component, with each other (e.g., associating different first and second QR codes with each other). Operations of associating the plurality of identifiers 103 with each other may include asserting, via a database entry, that the plurality of identifiers 103 each identify the physical component. In particular, FIG. 3D illustrates an example in which the plurality of identifiers 103 include different first and second identifiers 103 that correspond to first and second databases, respectively. The inventive entity appreciates, however, that the assertion may be made for more than two identifiers 103 located on the physical component. Specifically, the assertion may be made for all identifiers 103 located on the physical component, even if the quantity of identifiers 103 located on the physical component is greater than two.

Referring again to FIG. 3D, operations of asserting that the plurality of identifiers 103 each identify the physical component may include modifying (Blocks 330D-1 and 330D-2) first and second database records of the first and second databases, respectively, to indicate that the first and second identifiers 103 both identify the physical component. Accordingly, the first and second database records may be linked/combined such that any one of the first and second databases will identify the physical component, which is identified by the first and second identifiers 103, as being the same physical component. Additionally or alternatively, operations of asserting that the plurality of identifiers 103 identify the physical component may include sending the assertion in a message (e.g., a message to a requester/operator).

Moreover, in some embodiments, third and fourth identifiers 103 that are on an additional physical component correspond to third and fourth databases, respectively, and the operations of FIG. 3D further include modifying third and fourth database records of the third and fourth databases, respectively, to indicate that the third and fourth identifiers 103 both identify the additional physical component.

As an alternative to first and second identifiers that are both QR codes on the same physical component, some embodiments provide that the first identifier is a QR code that is on (and unique to) the physical component, whereas the second identifier is a non-QR-code identifier that is on (and unique to) the physical component. In such embodiments, operations of determining (Block 310D) that the plurality of identifiers 103 that are unique to the physical component are located on the physical component include determining, via the image processing, that the QR code and the non-QR-code identifier are located on the physical component. Moreover, operations of associating the plurality of identifiers 103 with each other include associating the QR code and the non-QR-code identifier with each other.

The inventive entity appreciates that a non-QR-code identifier, as described herein, may refer to any type of unique identifier 103 other than a QR code. As an example, a non-QR-code identifier may be a license plate number, a serial number, or any other unique coded reference identifier that is not a QR code.

In some embodiments, the operations of FIG. 3D (e.g., the operations of Block 320) may include recognizing content of the plurality of identifiers 103 that are unique to the physical component, and performing respective database queries, using the content of the plurality of identifiers 103. As an example, the queries may be queries of first and second databases corresponding to the first and second identifiers 103, respectively, of FIG. 3D. Moreover, in some embodiments, recognizing the content of the plurality of identifiers 103 may include recognizing an Uniform Resource Identifier (URI) of the plurality of identifiers 103 that are unique to the physical component. Accordingly, in some embodiments, operations of retrieving (Block 320, FIG. 3D) the attribute may include retrieving the attribute using a recognized URI (e.g., using an Uniform Resource Locator (URL) that is provided by one of the plurality of identifiers 103). The inventive entity also appreciates that each of the plurality of identifiers 103 may have its own URI, and that the operations of FIG. 3D may further include using the URI of each of the identifiers 103 for a database query.

Referring still to FIGS. 3A-3D, the inventive entity appreciates that identity reconciliation may not be successfully performed for an object if only one unique identifier 103 is located on the object. For example, unless a plurality of unique identifiers 103 are located on the object, the operations of Block 330 of FIG. 3A of storing the identifiers 103 with an association to the attribute of the physical component may not be successfully performed. If, however, more than one unique identifier 103 is located on the object (e.g., more than one QR code on an IT component casing), then reconciliation of the identity of the object may be provided across multiple databases (e.g., multiple IT management systems).

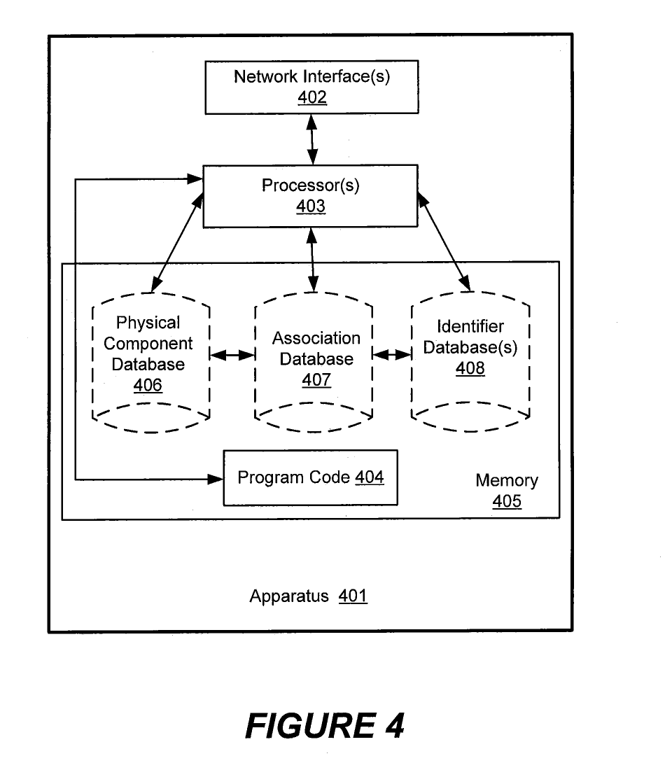

Referring to FIG. 4, a block diagram is provided of an apparatus 401 that is configured according to various embodiments described herein. The apparatus 401 may include at least one wired or wireless network interface 402. The apparatus 401 may include at least one processor 403 that may provide generic processor functions, computational functions, signal processing, and/or image processing. Moreover, the apparatus 401 may include a memory 405, which may include program code 404.

The memory 405 may also include a physical object/component database 406, an association database 407, and/or a coded reference identifier database(s) 408. Alternatively, the physical object/component database 406, the association database 407, and/or the coded reference identifier database(s) 408 may be remote from the apparatus 401. The physical object/component database 406 may include records including information related to the data center equipment 102. The coded reference identifier database(s) 408 may include information identified by one or more coded reference identifiers. For example, a coded reference identifier may indicate an URL that references a record in the coded reference identifier database(s) 408. The association database 407 may include records that indicate an association between records in the physical object/component database 406 and records in the coded reference identifier database(s) 408. The association may be provided, for example, by the operations of Block 330 of FIG. 3A.

The apparatus 401 of FIG. 4 may be used to perform automatic identity reconciliation according to various embodiments described herein. This apparatus 401 may be embodied as one or more enterprise, application, personal, pervasive and/or embedded computer systems and/or apparatuses that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 405 coupled to the processor 403 includes computer readable program code that, when executed by the processor 403, causes the processor 403 to perform operations including any of the operations described herein with respect to FIGS. 3A-3D.

Additional Discussion:

Identity reconciliation may be a problem in large IT environments because an element of an IT infrastructure may lack a universal identifier. Rather, multiple identifiers may be used for the same element and may correspond to different databases/systems. For example, different databases/systems may use different nomenclature for the same element/object. As an example, a server may be identified by three different identifiers in three different systems: (1) an asset number in an asset management system, (2) an IP address in a network management system, and (3) a name in an application management system. Because none of these three identifiers may be globally identified by all three systems, nor have any intrinsic relationship with each other, the identity reconciliation problem may persist. For example, if a user (e.g., an operator at an operator work station 10 of FIG. 1A) is provided with the (1) asset number of the asset management system, the user may not be able to use the asset number to identify the (2) IP address of the server of the network management system or the (3) name of the server of the application management system. In other words, because different databases corresponding to the different systems lack more than one of the three identifiers, a user viewing multiple ones of the identifiers via the respective databases may not be able to determine whether the multiple identifiers identify the same object.

According to various embodiments described herein, however, automatic identity reconciliation using image processing may be provided when different identifiers corresponding to different IT management systems (and thus different databases) are physically pasted, or otherwise marked, on the physical casing of an IT component. As an example, when multiple QR codes corresponding to respective IT management systems are physically located on the same case, URI references in the QR codes may be automatically recognized via image processing, and information records of the IT management systems may be linked together into a set that allows reconciled identification of the IT component in multiple databases. Accordingly, various embodiments described herein may address the identity reconciliation problem by performing automatic identity reconciliation using image recognition/processing technology.

For example, two QR codes on the same object should both pertain to that same object and may have respective references/links to database records. Accordingly, identity reconciliation can be performed by asserting in each database that the two QR codes pertain to the same object. As an example, one of the QR codes may correspond to an asset number and the other one of the QR codes may correspond to an IP address, and identity reconciliation may be performed by asserting in each database that the asset number and the IP address identify the same object. The inventive entity appreciates, however, that identity reconciliation may alternatively be performed using a QR code and one or more non-QR-code identifiers, as described herein.

Moreover, although various examples are described herein with respect to a distributed computer system (e.g., IT equipment such as data center equipment at a data center), the inventive entity appreciates that the automatic identity reconciliation operations described herein are not limited to a distributed computer system. For example, instead of performing image recognition/processing of multiple identifiers that are located on a physical component in a distributed computer system, the automatic identity reconciliation operations described herein may be performed for multiple identifiers that are located on a bus, a train, a car, a truck, a delivery parcel (e.g., a delivery envelope or package), etc. In particular, the automatic identity reconciliation operations may be performed for any physical object with multiple unique identifiers (e.g., where at least one of the unique identifiers is a QR code). As an example, the automatic identity reconciliation operations may be performed for a car, where the multiple identifiers include (i) a license plate and (ii) a QR code that are both located on the car.

Accordingly, the operations of automatic identity reconciliation described herein may include determining, via image processing (e.g., any type of electronic image processing), that a plurality of identifiers that are unique to a particular object are located on the particular object, and may further include associating the plurality of identifiers with each other. For example, the operations of Block 320 may be omitted when performing the operations of automatic identity reconciliation. Moreover, the operations of Block 330 may be performed irrespective of any attributes, as the inventive entity appreciates that attributes (but not identifiers) are optional for reconciliation purposes. In some embodiments, operations of associating the plurality of identifiers with each other may include asserting, via a database entry or via an electronic message, that the plurality of identifiers each identify the particular object (i.e., the same, individual object). Moreover, operations of asserting that the plurality of identifiers each identify the particular object may include linking or combining respective database records of databases corresponding to the plurality of identifiers with each other.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a Random Access Memory (RAM), a Read-Only Memory (ROM), an Erasable Programmable Read-Only Memory (EPROM or Flash memory), an appropriate optical fiber with a repeater, a portable Compact Disc Read-Only Memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, Radio Frequency (RF), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python, etc., procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a Local Area Network (LAN) or a Wide Area Network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described to best explain the principles of the disclosure and the practical application, and to enable others of ordinary skill in the art to understand the disclosure with various modifications as are suited to the particular use contemplated.

What is claimed is:

1. A method comprising:
identifying a plurality of identifiers that are spaced apart from each other within a digital image of a physical component in a distributed computer system;
retrieving an attribute of the physical component based on one of the plurality of identifiers; and
storing the plurality of identifiers with an association to the attribute of the physical component.

2. The method of claim 1, further comprising:
excluding from the plurality of identifiers any identifiers that are not determined to be located on a surface of the physical component within the digital image.

3. The method of claim 2, wherein excluding from the plurality of identifiers any identifiers that are not determined to be located on the surface of the physical component within the digital image, comprises:
identifying a boundary of the surface of the physical component in the digital image; and
constraining identifying the plurality of identifiers to occurring within the boundary of the surface of the physical component in the digital image.

4. The method of claim 3, further comprising:
identifying, within the digital image, a plurality of physical components in the distributed computer system; and
for each of the plurality of physical components identified within the digital image, repeating the identifying of the boundary and repeating the constraining of the identifying of the plurality of identifiers to occurring within the boundary.

5. The method of claim 2, wherein identifying the plurality of identifiers that are spaced apart from each other within the digital image of the physical component in the distributed computer system, comprises:
excluding from the plurality of identifiers any identifiers that are not determined to be located at least a threshold distance apart from each other on the surface of the physical component within the digital image.

6. The method of claim 1, wherein retrieving the attribute of the physical component comprises:
retrieving a first attribute of the physical component from a first management database based on a first one of the plurality of identifiers; and
retrieving a second attribute of the physical component from a second management database based on a second one of the plurality of identifiers.

7. The method of claim 6, wherein:
retrieving the first attribute of the physical component from the first management database based on the first one of the plurality of identifiers, comprises querying an asset management database using the first one of the plurality of identifiers to retrieve an asset number identity of the physical component; and
retrieving the second attribute of the physical component from the second management database based on the second one of the plurality of identifiers, comprises querying a network management database using the second one of the plurality of identifiers to retrieve an Internet Protocol (IP) address of the physical component.

8. The method of claim 1,
wherein the attribute comprises a rack number of the physical component in the distributed computer system, and
wherein retrieving the attribute comprises retrieving the rack number of the physical component based on one of the plurality of identifiers.

9. The method of claim 1,
wherein the plurality of identifiers are unique to the physical component in the distributed computer system,
wherein identifying the plurality of identifiers comprises determining, via image processing of the digital image, that the plurality of identifiers that are unique to the physical component are located on the physical component, and
wherein storing the plurality of identifiers comprises associating the plurality of identifiers, that are unique to the physical component, with each other.

10. The method of claim 9, wherein retrieving the attribute comprises:
recognizing content of the plurality of identifiers that are unique to the physical component; and
performing respective database queries, using the content of the plurality of identifiers.

11. The method of claim 10, wherein recognizing the content of the plurality of identifiers comprises recognizing an Uniform Resource Identifier (URI) of the plurality of identifiers that are unique to the physical component.

12. The method of claim 9, wherein associating the plurality of identifiers with each other comprises:
asserting, via a database entry, that the plurality of identifiers each identify the physical component.

13. The method of claim 12,
wherein the plurality of identifiers comprise different first and second identifiers that correspond to first and second databases, respectively, and
wherein asserting that the plurality of identifiers each identify the physical component comprises:
modifying first and second database records of the first and second databases, respectively, to indicate that the first and second identifiers both identify the physical component.

14. The method of claim 9,
wherein the plurality of identifiers that are unique to the physical component comprise different first and second Quick Response (QR) codes that are on the physical component,
wherein determining comprises determining, via the image processing, that the different first and second QR codes are located on the physical component, and
wherein associating comprises associating the different first and second QR codes with each other.

15. The method of claim 9,
wherein the plurality of identifiers that are unique to the physical component comprise first and second identifiers,
wherein the first identifier comprises a Quick Response (QR) code that is on the physical component,
wherein the second identifier comprises a non-QR-code identifier that is on the physical component,
wherein determining comprises determining, via the image processing, that the QR code and the non-QR-code identifier are located on the physical component, and
wherein associating comprises associating the QR code and the non-QR-code identifier with each other.

16. The method of claim 1,
wherein the physical component comprises a first physical component in the distributed computer system,
wherein the plurality of identifiers comprise a first plurality of identifiers that are located on the first physical component,
wherein the attribute comprises a first attribute of the first physical component,
wherein storing the plurality of identifiers comprises storing the first plurality of identifiers with an association to the first attribute of the first physical component, and
wherein the method further comprises:
identifying, within the digital image, a second plurality of identifiers that are spaced apart from each other on a second physical component in the distributed computer system;
retrieving a second attribute of the second physical component based on one of the second plurality of identifiers; and
storing the second plurality of identifiers with an association to the second attribute of the second physical component.

17. The method of claim 16,
wherein the first plurality of identifiers comprises first and second identifiers that correspond to first and second databases, respectively,
wherein storing the first plurality of identifiers with an association to the first attribute of the first physical component comprises:
modifying first and second database records of the first and second databases, respectively, to indicate that the first and second identifiers both identify the first physical component,
wherein the second plurality of identifiers comprises third and fourth identifiers that correspond to third and fourth databases, respectively, and
wherein storing the second plurality of identifiers with an association to the second attribute of the second physical component comprises:
modifying third and fourth database records of the third and fourth databases, respectively, to indicate that the third and fourth identifiers both identify the second physical component.

18. An apparatus comprising:
a processor; and
a memory coupled to the processor and comprising computer readable program code that when executed by the processor causes the processor to perform operations comprising:
identifying a plurality of identifiers that are spaced apart from each other within a digital image of a physical component in a distributed computer system;
retrieving an attribute of the physical component based on one of the plurality of identifiers; and
storing the plurality of identifiers with an association to the attribute of the physical component.

19. The apparatus of claim 18,
wherein the plurality of identifiers are unique to the physical component in the distributed computer system,
wherein identifying the plurality of identifiers comprises determining, via image processing of the digital image, that the plurality of identifiers that are unique to the physical component are located on the physical component, and
wherein storing the plurality of identifiers comprises associating the plurality of identifiers, that are unique to the physical component, with each other.

20. A computer program product comprising:
a computer readable storage medium comprising computer readable program code embodied in the medium therewith, the computer readable program code comprising:
computer readable program code to identify a plurality of identifiers that are spaced apart from each other within a digital image of a physical component in a distributed computer system; and
computer readable program code to retrieve an attribute of the physical comonent based on one of the plurality of identifiers; and
computer readable program code to store the plurality of identifiers with an association to the attribute of the physical component.
